(19) United States
(12) Patent Application Publication
(10) Pub. No.: US 2012/0107635 A1
(43) Pub. Date: May 3, 2012

(54) DEVICE FOR CONTROLLING THE TEMPERATURE OF AN ENERGY STORE AND METHOD FOR PRODUCING THE DEVICE FOR CONTROLLING THE TEMPERATURE

(76) Inventors: Stefan HIRSCH, Stuttgart (DE); Achim Wiebelt, Deidesheim (DE); Klaus Dieter Foerster, Ludwigsburg (DE)

(21) Appl. No.: 13/245,410

(22) Filed: Sep. 26, 2011

Related U.S. Application Data
(63) Continuation of application No. PCT/EP2010/053690, filed on Mar. 22, 2010.

(30) Foreign Application Priority Data
Mar. 24, 2009 (DE) 10 2009 014 144.8

(51) Int. Cl. B32B 15/00; B23K 1/00; B32B 3/02; B32B 3/24; B32B 3/30; B32B 1/02

(52) U.S. Cl. 428/596; 428/172; 428/166; 428/34.1; 428/68; 428/600; 228/101; 228/221

(57) ABSTRACT

A device for controlling the temperature of an energy store is provided. The device includes a contact element having a contact area for providing a thermal coupling to the energy store, a fluid channel, which is arranged in the contact element, and an insulating apparatus, which is arranged in the contact element.

This nonprovisional application is a continuation of International Application No. PCT/EP2010/053690, which was filed on Mar. 22, 2010, and which claims priority to German Patent Application No. DE 10 2009 014 144.8, which was filed in Germany on Mar. 24, 2009, and which are both herein incorporated by reference.

### BACKGROUND OF THE INVENTION

1. Field of the Invention

The present invention relates to a device for controlling the temperature of an energy store and to a method for producing a device for controlling the temperature of an energy store.

2. Description of the Background Art

Modern high-performance batteries, for example based on lithium ion technology, such as those used for electric vehicles and other applications, exhibit significantly accelerated aging starting at certain temperatures of, for example, greater than 40° C. At low temperatures of, for example, below 10° C., the electric power that is available decreases significantly. The objective is therefore to maintain the battery, or the battery cells, at a suitable working temperature to the extent possible. This applies both during operation of the car or equipment and during standstill. In the summer, temperatures of, for example, up to 70° C. are reached during standstill and with strong incident sunshine, while in the winter temperatures, for example, as low as −20° C. are reached during operation with cold outside temperatures and headwind. The efforts during operation are at times great to maintain the battery at an optimal working temperature by means of battery cooling and heating devices. During standstill, however, these units are typically not available, or the operation thereof entails high additional energy consumption.

The battery can be cooled or heated by a cooling or heating plate. For this purpose, a combination of battery cells (for example a stack) can be disposed on a brazed “cooling plate” containing inner channels for a cooling medium, for example a refrigerant or coolant. Such a cooling plate can be used to dissipate the waste heat of the battery.

Conventional systems have so far provided only little or no insulation because the main focus of attention was directed at removing the waste heat during operation or during rapid charging. Good insulation is rather an impediment in this case.

DE 39 40 649 A1, which corresponds to U.S. Pat. No. 5,137,169, describes a vacuum thermal insulation unit, which can be used, for example, for thermally insulating high-temperature batteries. The thermal insulation unit can be evacuated by means of a vacuum pump.

DE 44 19 281 C1, which corresponds to 5,824,432, describes a high-temperature battery, in particular for supplying energy to electrically powered vehicles, comprising a thermally insulating housing and a cooling system having a cooling body, which is arranged inside the thermally insulating housing and through which air flows and which penetrates the thermally insulating wall of the housing solely by air inlet and air outlet connectors disposed on the body.

### SUMMARY OF THE INVENTION

It is therefore an object of the present invention to provide a device for controlling a temperature of an energy store and a method for producing a device for controlling the temperature of an energy store.

The present invention is based on the finding that the aging effects in high-performance batteries can be reduced by means of thermally highly efficient vacuum insulation.

According to an embodiment of the invention, integrated vacuum insulation in housing components of the battery is provided, for example in the form of a cooling plate or a complete battery housing. This can minimize the losses of the heating or cooling energy that is supplied. This is done analogously to a residential building, where the temperature should be controlled within a comfortable range throughout the year to the extent possible. In addition, temperature changes, and hence undesirable extreme temperatures, can be minimized during standstill.

Advantageously, highly efficient integrated insulation can be created in the components in which a cooling medium is transported or by which the temperature of the battery is controlled. Thus, a battery containing vacuum insulation can be created. This also allows insulation during standstill, whereby the service life of the battery is extended.

The production method according to the invention makes it possible to implement the vacuum insulation by means of a brazing process, which is already used to produce conventional cooling plates. No additional method steps are thus required to create the vacuum insulation according to the invention.

The present invention creates a device for controlling the temperature of an energy store, having the following characteristics: a contact element having a contact surface for providing thermal coupling to the energy store; a fluid channel disposed in the contact element; and an insulating unit disposed in the contact element.

The device for controlling the temperature may be a cooling plate, or part of a housing, which is thermally coupled to the energy store. The energy store may be a galvanic cell, for example a battery or a rechargeable battery. The contact element may be a body made of a material having high thermal conductivity, for example metal. The contact element can have a multilayer design. The contact element can be connected to the energy store by way of the contact surface. The fluid channel can be designed to conduct a cooling or heating medium, for example a cooling agent. The contact element, and notably the contact surface, can be cooled or heated by way of the fluid channel. The insulating unit can be designed to reduce heat exchange between the energy store and surroundings of the energy store by way of the contact element. The insulating unit can be used to achieve heat exchange by way of the contact element, controlled exclusively or primarily by the fluid channel. A plurality of fluid channels and/or insulating units can be disposed inside the contact element.

The fluid channel can be disposed between the contact surface and the insulating unit. The insulating unit can thus form a thermal shield.

According to one embodiment, the insulating unit can be designed as a hollow chamber. The insulating unit can thus be designed in the form of vacuum insulation.

The device according to the invention may comprise a cover, which is designed to enclose the contact element on a side remote from the contact surface. The cover can form an outer housing seal.

To this end, a gap may be located between the cover and the contact element, the gap being connected to the insulating unit. Large-surface-area insulation can thus be created.

Moreover, the cover can comprise spacers, which are designed to support the cover over the gap with respect to the contact element. Thus, a size of the gap can be determined.

The device according to the invention may also comprise a support element, which is disposed inside the insulating unit and suitably designed to increase the strength of the contact element and support the cover over the gap with respect to the contact element. In this way, a support structure can be formed that prevents the cover from having contact. The support element can be designed as a rib, and more particularly as a corrugated rib.

According to one embodiment, the contact element can be composed of a plurality of laminated sheet metals and the insulating unit can extend through at least two of the laminated sheet metals. The laminated sheet metals enable a simple and stable design of the contact element.

The contact element may comprise, for example, at least one first laminated sheet metal, at least one second laminated sheet metal, at least one third laminated sheet metal, and at least one fourth laminated sheet metal, which are stacked on top of each other, wherein the at least one first laminated sheet metal is designed to form the contact surface, the at least one fluid channel is disposed in at least one second laminated sheet metal, and the at least one insulating unit is disposed in the at least one fourth laminated sheet metal.

The present invention further creates a method for producing a device for controlling the temperature of an energy store, comprising the following steps: providing a contact element having a contact surface for providing thermal coupling to the energy store, wherein at least one hollow chamber comprising a ventilation opening is disposed in the contact element; evacuating the hollow chamber via the ventilation opening; and closing the ventilation opening by means of a brazing process.

The ventilation opening can be a through-hole, which connects the hollow chamber to an outer surface of the contact element. Air present in the hollow chamber can be removed, for example, through the ventilation opening, thus creating a vacuum, or a partial vacuum, inside the hollow chamber. For this purpose, a plurality of ventilation openings may be provided. The brazing process can be a process that is used for producing the contact element. As an alternative, it can be a process that is conducted specifically for closing the ventilation opening. In order to close the ventilation opening, a suitable filler metal deposit can be provided in a surrounding area of the ventilation opening.

The contact element may be composed of a plurality of laminated sheet metals, and the plurality of laminated sheet metals can be connected to each other by means of the brazing process. In this way, no additional method stop is required to close the ventilation opening.

Moreover, one of the laminated sheet metals can be configured as a cover, and the ventilation opening can be disposed in a contact area between the cover and a further one of the laminated sheet metals. The ventilation opening can thus be located in a filler metal-conducting layer, which is provided for brazing the cover to the further laminated sheet metal. The ventilation opening can be closed by melting on the filler metal-conducting layer during the brazing process.

The brazing process can be a vacuum brazing process. The evacuation of the hollow chamber, or the preservation of the evacuation, during the brazing process can thus be ensured.

According to one embodiment, the ventilation opening can be designed to be a hole, knurl or notched structure.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is an illustration of a device for controlling the temperature of an energy store according to one exemplary embodiment of the present invention;

FIG. 2 is an illustration of a device for controlling the temperature of an energy store according to one exemplary embodiment of the present invention; and

FIG. 3 is a flow chart illustrating an embodiment.

### DETAILED DESCRIPTION

The following description of the exemplary embodiments of the present invention uses identical or similar reference numerals for similarly acting elements that are shown in the various drawings, wherein a repeat description of these elements has been dispensed with.

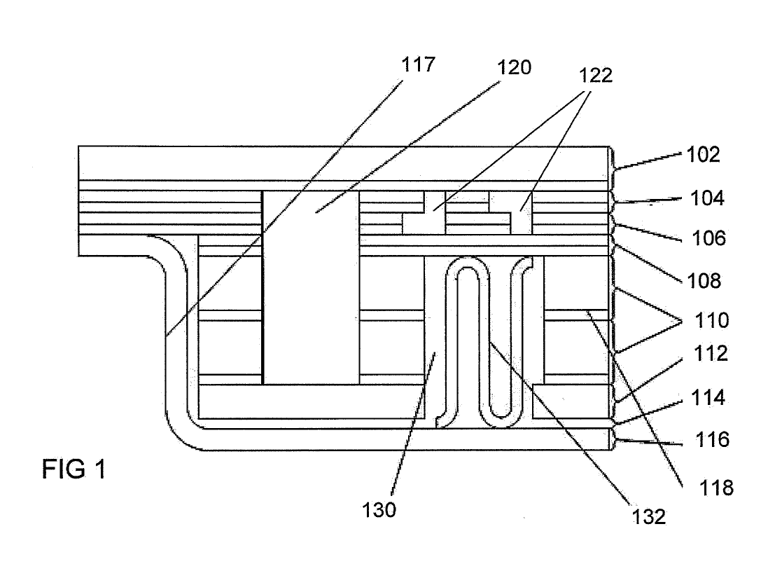

FIG. 1 shows a side view of a device for controlling the temperature of an energy store according to one exemplary embodiment of the present invention. According to this exemplary embodiment, the device is designed as a cooling plate comprising vacuum insulation.

The device comprises a contact element, which according to this exemplary embodiment has a cover 102, a first laminated sheet metal 104, a second laminated sheet metal 106, a third laminated sheet metal 108, a fourth and a fifth laminated sheet metal 110, a sixth laminated sheet metal 112, a gap 114, and a cover 116. The cover 116 may have a chamfer 117. Stiffeners 118 may be disposed between individual laminated sheet metals. A first fluid channel 120 and two further fluid channels 122 are disposed in the contact element. Moreover, an insulating unit 130 comprising a support structure 132 is disposed in the contact element. As an alternative, the device may comprise further elements, or only some of the elements described.

The cover 102 can be designed as a top cover, which is filler metal-cladded on one side. The cover 102 may comprise a contact surface for providing thermal coupling to the energy store. The energy store can, for example, by connected to the contact surface of the cover 102 in a planar manner. The laminated sheet metals 104, 106, 108, 110 can be designed as laminated sheet metals comprising filler metal cladding on one side. The filler metal cladding can be provided beneath the respective element in each case, relative to the view of FIG. 1. According to this exemplary embodiment, the stiffener 118 is disposed between the fourth and fifth laminated sheet metals 110 to serve as a layer that increases strength. The surface-area extension of the laminated sheet metals 102, 104, 106 can be larger than that of the laminated sheet metals 108, 110, 112, so that the contact element has a gradation. The bottom cover 116 can follow the course of the gradation and thus provide the chamfer 117, which allows thermal stresses to be compensated for. The gap 114 can extend over the surface of the sixth laminated sheet metal 112 facing the cover 116 and over the region of the chamfer 117. The gap 114 can thus form a large-surface-area insulation around the contact element. The cover 116 can be connected to an exposed surface of the second laminated sheet metal 106.

The first fluid channel 120 can be representative of distribution channels or collection channels. The two further fluid channels 122 can be used to control the temperature of the cover. The insulating unit 130 can be designed as an evacuated region.

The support structure 132 can be disposed inside the evacuated region 130. The support structure 132 may extend over the entire depth of the evacuated region 130 and, according to this exemplary embodiment, can support the cover 116 with respect to the third laminated sheet metal 108. The cover 116 can thus be prevented from being planarly seated against the sixth laminated sheet metal 112 as a result of a negative pressure that is present in the gap 114. The support structure 132 may comprise ribs, for example 8.0 mm ribs serving as the support structure or bracing element.

According to this exemplary embodiment, the first fluid channel 120 has a rectangular cross-section and extends over the laminated sheet metals 104, 106, 108, 110. Each of the second fluid channels 122 has an L-shaped cross-section and extends over the laminated sheet metals 104, 106. The evacuated region 130 has a rectangular cross-section and extends over the laminated sheet metals 110, 112 and is open with respect to the gap 114.

The evacuated region 130 can originally be connected to the surroundings of the contact element either directly or over the gap 114 via one or more ventilation openings. According to this exemplary embodiment, the cover 106 is in contact with the second filler metal-conducting layer 106. A ventilation opening, for example, can be provided in this contact area. The evacuated region 130 and the gap 114 can be evacuated during production through the ventilation opening. The evacuation can be carried out during a brazing process in which the stacked layers 102, 104, 106, 108, 110, 112, 114, 116 are connected to each other in a brazing furnace. To this end, the thin layers disposed between the individual sheet metals can be melted on with filler metal and create a permanent bond between the stacked layers 102, 104, 106, 108, 110, 112, 114, 116 upon cooling. The molten filler metal can flow into or over the ventilation opening and permanently close it upon cooling. If the brazing process is performed as a vacuum brazing process, the evacuation and brazing can be carried out in one and the same step.

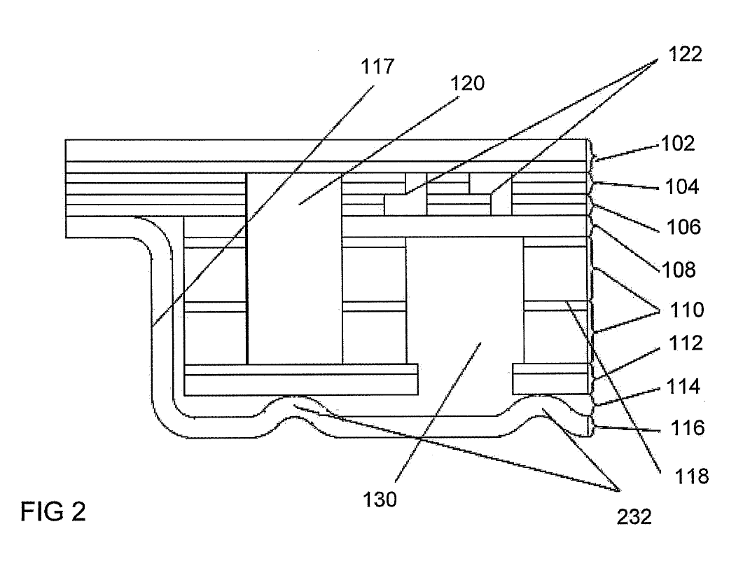

FIG. 2 shows a side view of a device for controlling the temperature of an energy store according to a further exemplary embodiment of the present invention. According to this exemplary embodiment, the device is designed as a cooling plate having vacuum insulation.

The device corresponds to the device shown in FIG. 1, wherein the support structure disposed in the evacuated region 130 has been replaced with corrugations 232 in the cover 116 serving as spacers and reinforcements or supports. The corrugations 232 can be designed as indentations or depressions in the cover 116. The cover 116 may be seated against the sixth laminated sheet metal 112 in the region of the corrugations 232. The cover 116 can thus be prevented from being planarly seated against the sixth laminated sheet metal 112 as a result of a negative pressure that is present in the gap 114. A further difference over the exemplary embodiment shown in FIG. 1 is that according to this exemplary embodiment, the second laminated sheet metal 106, instead of the sixth laminated sheet metal 112, can be designed to be filler metal-cladded on one side.

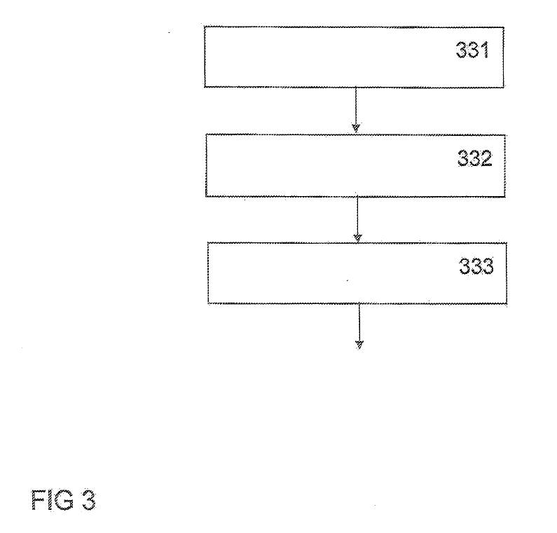

FIG. 3 shows a flow chart of a method for producing a device for controlling the temperature of an energy store, as that which is shown, for example, in FIGS. 1 and 2.

In a first step 331, a contact element having a contact surface for providing thermal coupling to the energy store can be provided. At least one hollow chamber comprising a ventilation opening can be disposed in the contact element. Moreover, at least one fluid channel can be disposed in the contact element. In a second step 332, the hollow chamber can be evacuated via the ventilation opening. In a third step 333, the ventilation opening, and thus the hollow chamber, can be permanently closed by means of a brazing process.

According to one exemplary embodiment of the method for producing a device for controlling the temperature of an energy store, regions may be integrated in the brazed component, for example of a cooling plate, that are evacuated prior to the brazing process and that are sealed by the brazing process, so that closed, evacuated regions remain after cooling. This can be done, for example, by small holes, through which trapped gas can escape during evacuation, but which in the subsequent vacuum brazing process are closed by adjacent filler metal. For this purpose, maintaining the vacuum during cooling at least partially is beneficial. Moreover, the components should be suitably structured, so that they cannot collapse or deform in an interfering manner as a result of the evacuated regions.

Instead of the holes, it is also possible to use knurls or notched structures in the filler metal or component surfaces to remove gas, these knurls or notched structures being so small or disposed so favorably in terms of the brazing position that they can be closed by the provided filler metal.

The exemplary embodiments described have been selected solely by way of example and can be combined with each other.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for controlling a temperature of an energy store, the device comprising:
a contact element having a contact surface for providing thermal coupling to the energy store;
a fluid channel disposed in the contact element; and
an insulating unit disposed in the contact element.

2. The device according to claim 1, wherein the fluid channel is disposed between the contact surface and the insulating unit.

3. The device according to claim 1, wherein the insulating unit is a hollow chamber.

4. The device according to claim 1, further comprising a cover that is configured to enclose the contact element on a side remote from the contact surface.

5. The device according to claim 4, wherein a gap, which is connected to the insulating unit, is disposed between the cover and the contact element.

6. The device according to claim 4, wherein the cover comprises spacers that are configured to support the cover over the gap with respect to the contact element.

7. The device according to claim 4, further comprising a support element that is disposed inside the insulating unit and configured to support the cover over the gap with respect to the contact element.

8. The device according to claim 1, wherein the contact element comprises a plurality of laminated sheet metals and the insulating unit extends at least through two of the laminated sheet metals.

9. The device according to claim 1, wherein the contact element comprises at least one first laminated sheet metal, at least one second laminated sheet metal, at least one third laminated sheet metal, and at least one fourth laminated sheet metal, which are stacked on top of each other, the at least one first laminated sheet metal being designed to form the contact surface, the at least one fluid channel being disposed in the at least one second laminated sheet metal, and the at least one insulating unit being disposed in the at least one fourth laminated sheet metal.

10. A method for producing a device for controlling a temperature of an energy store, the method comprising:
providing a contact element having a contact surface for providing thermal coupling to the energy store;
arranging at least one hollow chamber having a ventilation opening in the contact element;
evacuating the hollow chamber via the ventilation opening; and
closing the ventilation opening via a brazing process.

11. The method according to claim 10, wherein the contact element comprises a plurality of laminated sheet metals and the plurality of laminated sheet metals are connected to each other by the brazing process.

12. The method according to claim 11, wherein one of the laminated sheet metals is configured as a cover and the ventilation opening is disposed in a contact area between the cover and a further one of the laminated sheet metals.

13. A method according to claim 10, wherein the brazing process is a vacuum brazing process.

14. The method according to claim 10, wherein the ventilation opening is a hole, knurl or notched structure.
